(19) United States
(12) Patent Application Publication
(10) Pub. No.: US 2024/0272090 A1
(43) Pub. Date: Aug. 15, 2024

(54) SENSOR SYSTEM AND METHOD OF MEASURING GAS-LIQUID RATIO

(71) Applicant: FUJI ELECTRIC CO., LTD., Kanagawa (JP)

(72) Inventors: Naoki TAKEDA, Tokyo (JP); Naomichi JIMBO, Tokyo (JP)

(21) Appl. No.: 18/644,555

(22) Filed: Apr. 24, 2024

Related U.S. Application Data
(63) Continuation of application No. PCT/JP2022/037664, filed on Oct. 7, 2022.

(51) Int. Cl. G01N 22/00

(52) U.S. Cl. CPC G01N 22/00

(57) ABSTRACT

With respect to a sensor system for measuring a gas-liquid ratio of a two-phase fluid flowing through a pipe, the sensor system includes a transmitter configured to transmit a radio wave to an inside of the pipe; a receiver configured to receive the radio wave from the inside of the pipe; and a controller configured to calculate the gas-liquid ratio based on a radio wave strength of the radio wave received by the receiver and a flow regime in the inside of the pipe.

### CROSS-REFERENCE TO RELATED APPLICATIONS

This application is a continuation application of International Application No. PCT/JP2022/037664, filed on Oct. 7, 2022, the entire contents of which are incorporated herein by reference.

### BACKGROUND

### 1. Technical Field

The present disclosure relates to a sensor system and a method of measuring a gas-liquid ratio.

### 2. Description of the Related Art

Patent Document 1 discloses a method of calculating a void fraction in a two-phase mixture extracted at a geothermal power plant. Patent Document 1 discloses, in a method of calculating a void fraction in a two-phase mixture, transmitting a radio frequency signal through a transportation pipe, receiving the radio frequency signal, calculating an average of signal strength attenuations, and calculating a void fraction of the two-phase mixture based on the average of the signal strength attenuations.

### RELATED ART DOCUMENT

### Patent Document

Patent Document 1: U.S. patent Ser. No. 10/670,541

### SUMMARY

According to an aspect of the present disclosure, with respect to a sensor system for measuring a gas-liquid ratio of a two-phase fluid flowing through a pipe, the sensor system includes a transmitter configured to transmit a radio wave to an inside of the pipe; a receiver configured to receive the radio wave from the inside of the pipe; and a controller configured to calculate the gas-liquid ratio based on a radio wave strength of the radio wave received by the receiver and a flow regime in the inside of the pipe.

### BRIEF DESCRIPTION OF THE DRAWINGS

FIG. 1 is a diagram for explaining an outline of a configuration of a sensor system according to a first embodiment;

FIG. 2 is a diagram for explaining a definition of a gas-liquid ratio;

FIG. 3 is a flow regime map illustrating flow regimes of a two-phase flow;

FIG. 4 is a diagram for explaining calibration curves used in the sensor system according to the first embodiment;

FIG. 5 is a flowchart for explaining processing of the sensor system according to the first embodiment;

FIG. 6 is a diagram for explaining an outline of a configuration of a sensor system according to a second embodiment;

FIG. 7 is a diagram for explaining influence on calibration curves used in the sensor system according to the second embodiment with respect to temperature;

FIG. 8 is a flowchart for explaining processing of the sensor system according to the second embodiment;

FIG. 9 is a diagram for explaining an outline of a configuration of a sensor system according to a third embodiment;

FIG. 10 is a flowchart for explaining processing of the sensor system according to the third embodiment;

FIG. 11 is a diagram for explaining an outline of a configuration of a sensor system according to a fourth embodiment; and

FIG. 12 is a flowchart for explaining processing of the sensor system according to the fourth embodiment.

### DETAILED DESCRIPTION

In a case where a radio wave is transmitted to an inside of a pipe, the strength of a reflected wave varies depending on a temperature and a flow regime of an internal fluid (generally water or water vapor), and therefore error may occur when a gas-liquid ratio is measured from strength attenuations of the radio wave.

It is desirable to provide a sensor system and a method of measuring a gas-liquid ratio, which are less affected by a flow regime when a radio wave is transmitted to an inside of a pipe to measure a gas-liquid ratio.

According to the sensor system and the method of measuring a gas-liquid ratio of the present disclosure, in a case where a radio wave is transmitted to an inside of a pipe to measure a gas-liquid ratio, the influence of a flow regime can be reduced.

Hereinafter, embodiments will be described with reference to the accompanying drawings. Note that the present disclosure is not limited to these examples, is indicated by the claims, and is intended to include all modifications within the meaning and scope equivalent to the scope of the claims.

In the specification and the drawings of the embodiments, components having substantially the same or corresponding functional configurations are denoted by the same reference symbols, and redundant description thereof may be omitted. For ease of understanding, the scale of each part in the drawings may be different from the actual scale.

### First Embodiment

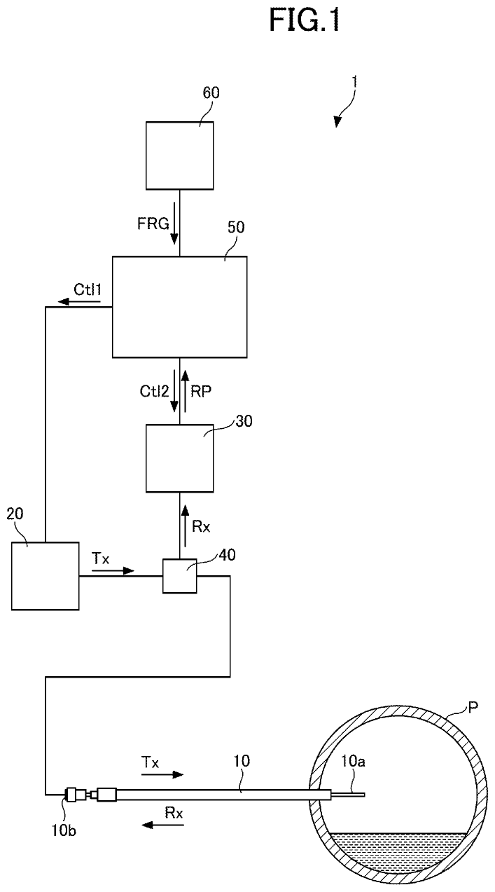

A sensor system according to a first embodiment will be described. The sensor system according to the first embodiment is a sensor system that measures a gas-liquid ratio of a two-phase fluid flowing through a pipe. The sensor system according to the first embodiment includes a transmitter that transmits a radio wave to an inside of a pipe, a receiver that receives the radio wave from the inside of the pipe, and a flow regime acquisition part that acquires a flow regime in the inside of the pipe. The sensor system according to the first embodiment also includes a controller that calculates the gas-liquid ratio based on both the radio wave received by the receiver and the flow regime in the inside of the pipe. FIG. 1 is a diagram for explaining an outline of a configuration of a sensor system 1, which is an example of the sensor system according to the first embodiment.

### <Sensor System 1>

The sensor system 1 is a system that measures a gas-liquid ratio of a two-phase fluid flowing through a pipe P. The sensor system 1, for example, measures a gas-liquid ratio in a geothermal flow. The sensor system 1 transmits a high-frequency signal (radio wave) to the inside of the pipe P, and calculates the gas-liquid ratio of the two-phase fluid flowing through the pipe P based on the radio wave that has been propagated through the pipe P and received.

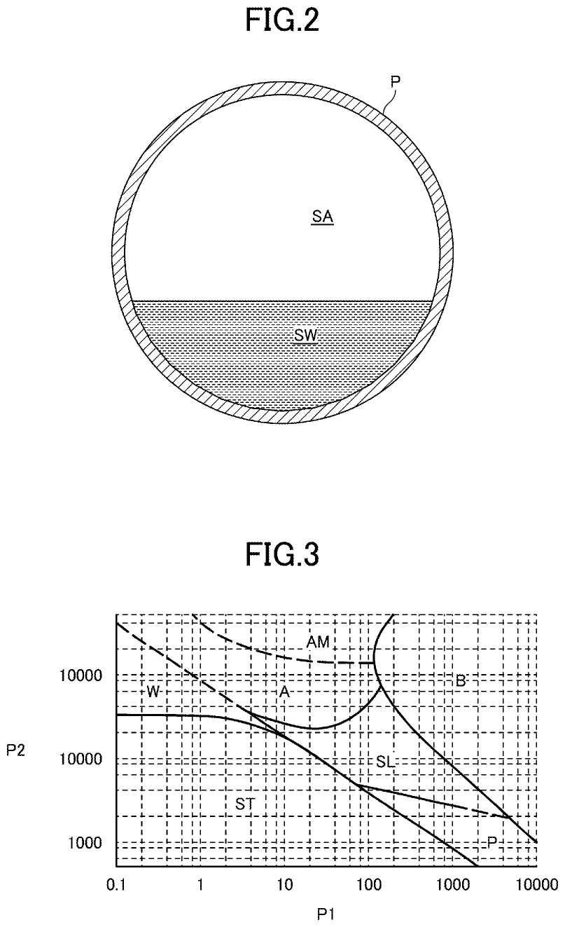

The gas-liquid ratio calculated by the sensor system 1 will be described. The gas-liquid ratio is a rate in the amount of liquid in the two-phase fluid flowing through the pipe P. FIG. 2 is a diagram for explaining a definition of the gas-liquid ratio. The gas-liquid ratio is a ratio of the amount of gas to the amount of liquid. The gas-liquid ratio is obtained by, for example, a ratio of areas of gas and liquid in a pipe cross section in a stationary state. In FIG. 2, SA represents a cross section of a gas-phase, and SW represents a cross section of a liquid-phase.

FIG. 2 depicts, as an example, the gas-liquid ratio in the pipe P whose inner cross section is circular. Setting the radius of the pipe P as R (in meters) and a cross-sectional area of the pipe P as S (in square meters), the cross-sectional area S is then obtained by Equation 1.

$$S = Π \times {R}^{2} \qquad Equation 1$$

Setting a cross-sectional area of the cross section SA of the gas-phase in FIG. 2 as Sa (in square meters) and a cross-sectional area of the cross section SW of the liquid-phase as Sw (in square meters), a void fraction α (dimensionless) is then as in Equation 2. A moisture fraction β (dimensionless) is as in Equation 3. A gas-liquid ratio Raw (dimensionless) is as in Equation 4.

$$α = Sa / S \qquad Equation 2$$

$$β = 1 - α = Sw / S \qquad Equation 3$$

$$Raw = α / β = ( 1 - β ) / β \qquad Equation 4$$

The sensor system 1 of FIG. 1 includes an antenna 10, a transmitter 20, a receiver 30, a directional coupler 40, a controller 50, and a flow regime acquisition part 60.

### [Antenna 10]

The antenna 10 transmits and receives a radio wave to and from the inside of the pipe P. The antenna 10 has a rod shape. A front end 10a of the antenna 10 is inserted into the pipe P through a hole provided in the pipe P. The antenna 10 transmits the radio wave to the inside of the pipe P via the front end 10a. The antenna 10 also receives the radio wave of the reflected wave that is reflected in the pipe P and returned, via the front end 10a. A rear end 10b of the antenna 10 is connected to the transmitter 20 and the receiver 30 via the directional coupler 40.

Here, the sensor system 1 includes one antenna 10 that transmits and receives the radio wave; however, it may include, for example, a transmitting antenna and a receiving antenna separately. Additionally, the shape of the antenna 10 is not limited to the shape illustrated in FIG. 1 as long as the antenna can transmit or receive the radio wave to or from the inside of the pipe P.

### [Transmitter 20]

The transmitter 20 generates a transmission signal Tx, which is an electric signal for transmitting a radio wave to the inside of the pipe P via the antenna 10. The transmitter 20 operates based on a control signal Ctl1 output from the controller 50. The transmitter 20 includes a high-frequency signal generation circuit. The high-frequency signal generation circuit generates, for example, a high-frequency signal that is a continuous wave having a frequency of 1 gigahertz and whose power is controlled (generally controlled to have a constant amplitude) by the controller 50. The high-frequency signal generation circuit is, for example, a voltage-controlled oscillator (VCO). The high-frequency signal generation circuit is preferably capable of adjusting the frequency in a desired frequency range, such as a range from 700 megahertz to 1 gigahertz.

### [Receiver 30]

The receiver 30 receives a reception signal Rx, which is an electric signal based on the radio wave received via the antenna 10. The receiver 30 converts, by performing analog-digital conversion on the reception signal Rx, the reception signal Rx into a radio wave strength RP on which the controller 50 can perform calculation. The receiver 30 outputs the radio wave strength RP to the controller 50.

### [Directional Coupler 40]

The directional coupler 40 outputs the transmission signal Tx input from the transmitter 20 to the antenna 10. The directional coupler 40 also outputs the reception signal Rx input from the antenna 10 to the receiver 30. The directional coupler 40 is, for example, a unidirectional coupler. The directional coupler is, for example, a loop directional coupler or a distributed coupling type directional coupler.

Note that the directional coupler 40 suppresses the transmission signal Tx from being input to the receiver 30 and suppresses the reception signal Rx from being input to the transmitter 20.

### [Flow Regime Acquisition Part 60]

A flow regime in the pipe is input to the flow regime acquisition part 60 from the outside. A flow regime map (Baker's map) according to Baker is illustrated in FIG. 3. FIG. 3 is a flow regime map, what is known as a Baker's map, illustrating a flow regime of a two-phase flow. The horizontal axis of FIG. 3 represents a variable P1 obtained by correcting a ratio of mass velocity between a liquid phase and a gas phase, with physical properties. The vertical axis of FIG. 3 represents a variable P2, which is the gas-phase mass velocity. FIG. 2 illustrates the existence range of each flow regime based on the observation results.

The reference symbols in FIG. 3 will be described. ST represents a region where the flow regime is a stratified flow. W represents a region where the flow regime is a wave flow. A represents a region where the flow regime is an annular flow. AM represents a region of a dispersed flow. SL represents a region of a slug flow. P represents a region of a plug flow. B represents a region of a bubble (or froth) flow.

The geothermal flow, which is an example of a subject of measurement of the sensor system 1, is generally a flow mainly containing steam due to the use of the geothermal flow. Therefore, the two-phase fluid flowing through the pipe P in the sensor system 1 is classified into, for example, either the wave flow or the stratified flow, or either the annular flow or the dispersed flow, in the Baker's map illustrated in FIG. 3. Note that a case where the flow regime is either the wave flow or the stratified flow is referred to as a flow regime FR1. Additionally, a case where the flow regime is either the annular flow or the dispersed flow is referred to as a flow regime FR2.

The flow regime acquisition part 60 may set, by an operator of a power plant, the flow regime based on a result of a tracer flow test (TFT) or an operation record in the past, for example. Additionally, the flow regime acquisition part 60 may acquire information on the flow regime from a higher-level device. Furthermore, the flow regime acquisition part 60 may acquire a result from a measuring device that determines the flow regime. The flow regime acquisition part 60 can be configured to receive signals corresponding to the assumed flow regimes (up to 7 regimes) and can have, for example, a 7-contact digital input, or a 3-bit input (such as parallel input), or a serial communication means (a serial communication interface) using a predetermined protocol.

The flow regime acquisition part 60 outputs a flow regime FRG, which has been acquired, to the controller 50.

### [Controller 50]

The controller 50 controls each of the transmitter 20 and the receiver 30. The controller 50 also calculates the gas-liquid ratio of the two-phase fluid flowing through the pipe P based on the radio wave strength RP received from the receiver 30 and the flow regime FRG acquired from the flow regime acquisition part 60.

The controller 50 includes, for example, a central processing unit (CPU), a random access memory (RAM), and a read only memory (ROM). The controller 50 performs processing by, for example, the CPU executing a program stored in the ROM.

The controller 50 transmits the control signal Ctl1 to the transmitter 20. The control signal Ctl1 includes, for example, set values of the transmission frequency and the transmission power of the radio wave, and the like. The controller 50 transmits a control signal Ctl2 to the receiver 30. The control signal Ctl2 includes, for example, set values for setting a time range and an averaging time for the radio wave strength RP to be taken in by the receiver 30, and the like.

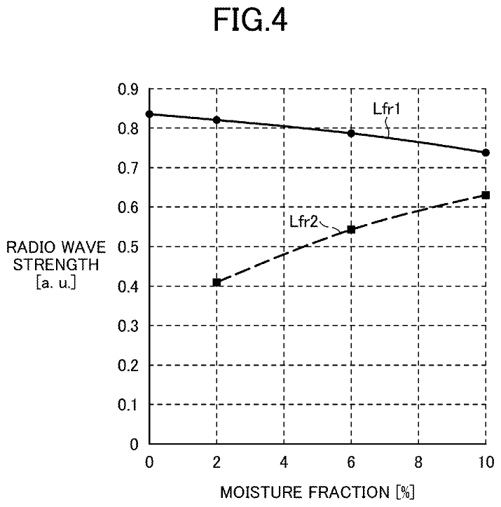

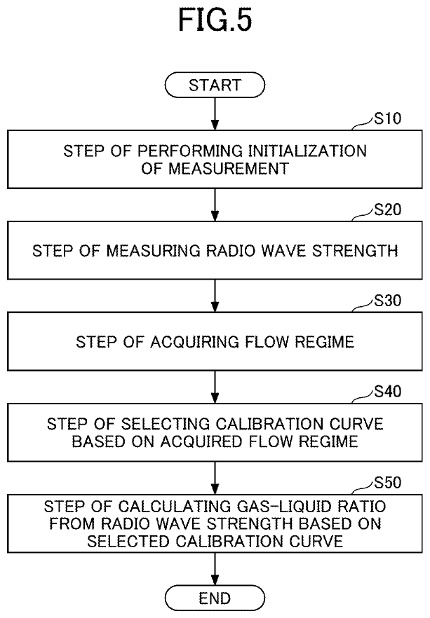

Additionally, the controller 50 receives the radio wave strength RP from the receiver 30. The controller 50 selects a calibration curve to be used from at least two calibration curves based on the flow regime FRG acquired from the flow regime acquisition part 60. Examples of the calibration curve are illustrated in FIG. 4. FIG. 4 is a diagram illustrating calibration curves used in the sensor system 1, which is an example of the sensor system according to the first embodiment. The calibration curve is a line indicating a relationship between the moisture fraction β and the radio wave strength RP of the radio wave. A line Lfr1 in FIG. 4 is a calibration curve in a case where the flow regime is either the wave flow or the stratified flow, that is, a case where the flow regime is the flow regime FR1. Additionally, a line Lfr2 in FIG. 4 is a calibration curve in a case where the flow regime is either the annular flow or the dispersed flow, that is, a case where the flow regime is the flow regime FR2. Note that FIG. 4 illustrates the results when the temperature of the two-phase fluid flowing through the pipe P is 80° C.

The inventors have found that the radio wave strength of the radio wave greatly varies depending on the flow regime as illustrated in FIG. 4. Thus, the inventors have found that the moisture fraction, that is, the gas-liquid ratio can be accurately obtained by the selecting from the multiple calibration curves based on the flow regime in the controller 50 of the sensor system 1.

### <Processing in Sensor System 1>

Next, processing in the sensor system 1, which is an example of the sensor system according to the first embodiment, will be described. A method of measuring the gas-liquid ratio according to the first embodiment will be described by describing the processing in the sensor system 1. FIG. 5 is a flowchart illustrating the processing of the sensor system 1, which is an example of the sensor system according to the first embodiment.

### (Step S10)

First, the sensor system 1 performs initialization of measurement (a step of performing initialization of measurement). Specifically, the controller 50 initializes an arithmetic memory.

### (Step S20)

The sensor system 1 measures a radio wave strength (a step of measuring the radio wave strength). The sensor system 1 transmits a radio wave to the inside of the pipe P via the antenna 10 and receives the radio wave via the antenna 10. The sensor system 1 then measures the radio wave strength of the radio wave received via the antenna 10.

Specifically, the controller 50 transmits the control signal Ctl1 to the transmitter 20. Then, the transmitter 20 that has received the control signal Ctl1 outputs the transmission signal Tx to the antenna 10. The transmitter 20 outputs the transmission signal Tx to the antenna 10 based on the frequency and the output power set by the control signal Ctl1 transmitted from the controller 50. Then, the antenna 10 transmits a radio wave based on the transmission signal Tx to the inside of the pipe P.

Next, the receiver 30 receives the reception signal Rx from the antenna 10. The receiver 30 then measures the radio wave strength RP in the pipe P based on the reception signal Rx. Specifically, the receiver 30 performs analog-digital conversion on the reception signal Rx directly or after signal detection to measure the radio wave strength RP. The receiver 30 transfers the measured radio wave strength RP to the controller 50. Note that, when the radio wave strength RP is calculated, the receiver 30 may perform averaging over the time range set in advance by the controller 50 to transfer the averaged result, as the radio wave strength RP, to the controller 50.

### (Step S30)

Next, the sensor system 1 acquires the flow regime (a step of acquiring the flow regime). Specifically, the flow regime acquisition part 60 acquires the flow regime of the two-phase fluid flowing through the pipe P. The flow regime acquisition part 60 then transmits the flow regime FRG to the controller 50. The controller 50 acquires the flow regime FRG from the flow regime acquisition part 60.

### (Step S40)

Next, the sensor system 1 selects the calibration curve based on the acquired flow regime (a step of selecting the calibration curve based on the acquired flow regime). Specifically, the controller 50 selects the calibration curve from the multiple calibration curves each indicating the relationship between the radio wave strength RP and the moisture fraction β based on the acquired flow regime FRG.

The calibration curve indicating the relationship between the radio wave strength RP and the moisture fraction β is determined based on the pipe shape, length, material, and the like of the pipe P. Furthermore, because the calibration curve has a different tendency depending on the flow regime as illustrated in FIG. 4, multiple calibration curves are prepared based on the types of flow regimes to be assumed. For example, a calibration curve for a case where the flow regime is either the wave flow or the stratified flow, that is, a case where the flow regime is the flow regime FR1, and a calibration curve for a case where the flow regime is either the annular flow or the dispersed flow, that is, a case where the flow regime is the flow regime FR2 are prepared.

The calibration curve indicating the relationship between the radio wave strength RP and the moisture fraction β may be obtained by performing the tracer flow test or the like in advance at the time of installation. Additionally, in a case where the system at the installation site can be reproduced as a simulation model, the calibration curve may be obtained by simulation. Further, in a case where the flow regime is changed for some reason, the controller 50 may change the frequency to a frequency at which the relationship between the radio wave strength RP and the moisture fraction β acquired in advance is close to linear.

### (Step S50)

Next, the sensor system 1 calculates the gas-liquid ratio from the radio wave strength based on the selected calibration curve (a step of calculating the gas-liquid ratio from the radio wave strength based on the selected calibration curve). Specifically, the controller 50 calculates the moisture fraction β from the radio wave strength RP based on the calibration curve selected in Step S40. The controller 50 then calculates the gas-liquid ratio Raw from the calculated moisture fraction β by Equation 4.

Note that, because the radio wave strength RP may suddenly be varied due to splash or the like in the pipe, the controller 50 may set a certain time range and take a moving average. The number of times to perform the moving average may be determined as appropriate in consideration of noise and the like. Here, when the noise is small, the number of times to perform the moving averages may be set to one, that is, the processing may be performed using the acquired radio wave strength RP itself.

In the above example, the number of calibration curves is two; however, the number of calibration curves may be three or more.

### <Conclusion>

According to the sensor system of the first embodiment, in a case where the radio wave is transmitted to the inside of the pipe to measure the gas-liquid ratio, the influence due to the flow regime can be reduced.

### Second Embodiment

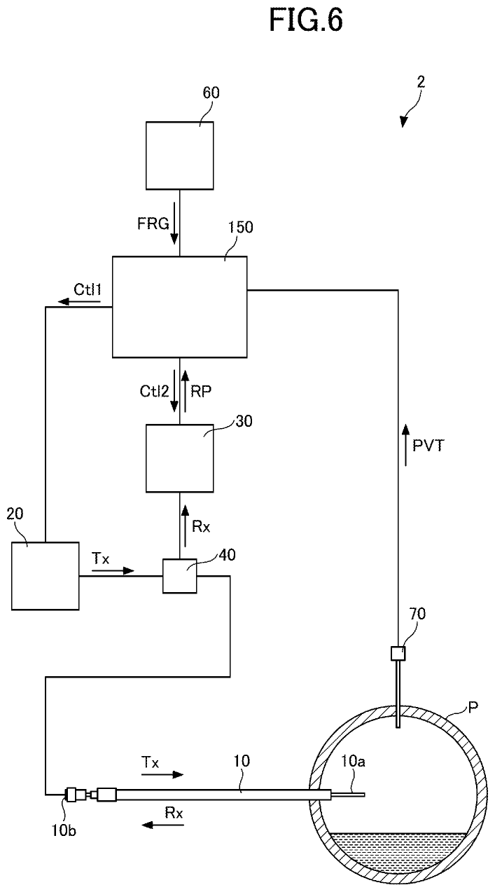

A sensor system according to a second embodiment will be described. The sensor system according to the second embodiment further includes a temperature acquisition part in the sensor system according to the first embodiment. A controller of the sensor system according to the second embodiment then calculates the gas-liquid ratio based on the radio wave received by the receiver, the temperature in the inside of the pipe, and the flow regime in the inside of the pipe. FIG. 6 is a diagram for explaining an outline of a configuration of a sensor system 2, which is an example of the sensor system according to the second embodiment.

### <Sensor System 2>

The sensor system 2 further includes a temperature acquisition part 70 in the sensor system 1, which is an example of the sensor system according to the first embodiment. The sensor system 2 then includes a controller 150 instead of the controller 50 in the sensor system 1. For the configuration of the sensor system 2 that is common to the sensor system 1, the description of the sensor system 1 is referred to, and the description thereof will be omitted here.

### [Temperature Acquisition Part 70]

The temperature acquisition part 70 measures the temperature in the inside of the pipe P. The temperature acquisition part 70 measures the temperature of the two-phase fluid flowing through the pipe P. The temperature acquisition part 70 transmits the measured temperature PVT to the controller 150.

The temperature acquisition part 70 includes, for example, a thermocouple and a resistance temperature detector. Additionally, the temperature acquisition part 70 may acquire the temperature considered to represent the temperature near the antenna 10 from the outside, for example.

### [Controller 150]

The controller 150 performs temperature correction on the selected calibration curve based on the temperature PVT acquired by the temperature acquisition part 70, in addition to the functions and the configuration of the controller 50.

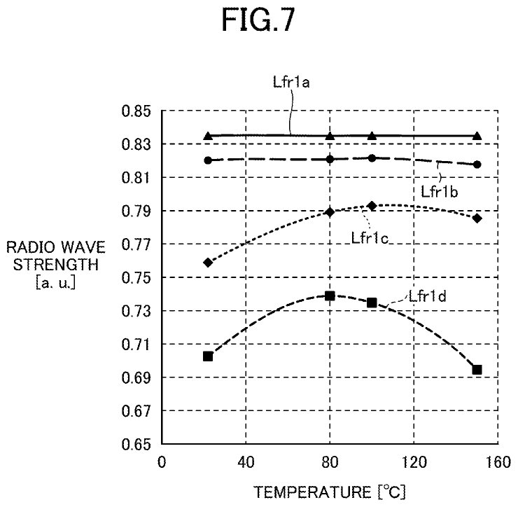

Influence of the temperature on the calibration curve is illustrated in FIG. 7. FIG. 7 is a diagram for explaining the influence on the calibration curves used in the sensor system 2, which is an example of the sensor system according to the second embodiment, with respect to the temperature.

FIG. 7 is a diagram illustrating the influence of temperature in a case where the flow regime is either the wave flow or the stratified flow, that is, a case where the flow regime is the flow regime FR1. The horizontal axis of FIG. 7 represents the temperature PVT. The vertical axis of FIG. 7 represents the radio wave strength RP. A line Lfr1a in FIG. 7 is a result when the moisture fraction β is 0%. A line Lfr1b in FIG. 7 is a result when the moisture fraction β is 2%. A line Lfr1c in FIG. 7 is a result when the moisture fraction B is 6%. A line Lfr1d in FIG. 7 is a result when the moisture fraction β is 10%.

As illustrated in FIG. 7, as the moisture fraction β increases, the radio wave strength is easily affected by the influence of the temperature.

As illustrated in FIG. 7, the controller 150 obtains changes of points on the calibration curve with respect to the temperature PVT of the two-phase fluid flowing through the pipe P in advance by actual measurement or simulation. The controller 150 then corrects the points on the calibration curve based on the obtained changes of the points on the calibration curve with respect to the temperature PVT of the two-phase fluid flowing through the pipe P.

As a factor of the calibration curve changing due to the temperature, changes in relative permittivity and dissipation factor of the fluid of the target are considered. Although more corrected points on the calibration curve achieve higher accuracy in measurement, work required for determining and calculating a correction equation based on actual measurement may be increased. Therefore, for example, data of about four points within a range of moisture fraction β that can be assumed may be acquired by actual measurement or simulation, and the intervals between the moisture fractions ß may be interpolated with a spline curve or the like. Furthermore, regarding the relationship between the temperature and the points on the calibration curve, because it takes time and effort to measure or simulate a large number of points, about four points may be acquired in the corresponding temperature range and interpolation may be performed with polynomial approximation.

### <Processing in Sensor System 2>

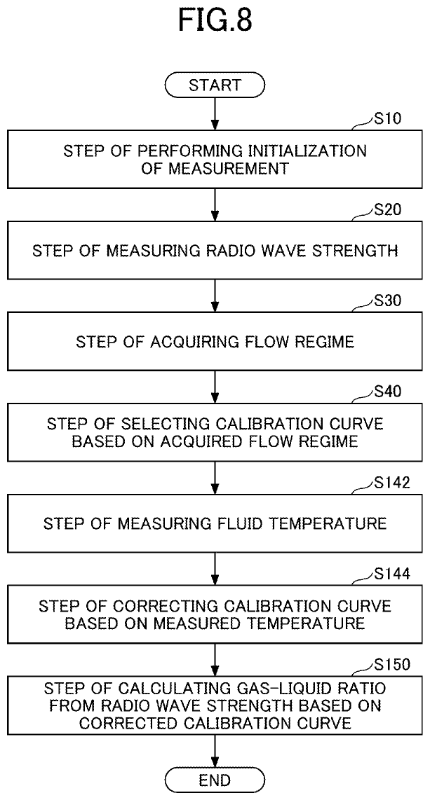

Next, processing in the sensor system 2, which is an example of the sensor system according to the second embodiment will be described. A method of measuring the gas-liquid ratio according to the second embodiment will be described by describing the processing in the sensor system 2. FIG. 8 is a flowchart for explaining the processing of the sensor system 2, which is an example of the sensor system according to the second embodiment.

Note that, for Step S10, Step S20, Step S30, and Step S40, the processing in the sensor system 1 is referred to, and the description thereof will be omitted here.

### (Step S142)

After Step S40, the sensor system 2 measures a fluid temperature (a step of measuring the fluid temperature). Specifically, the temperature acquisition part 70 measures the temperature in the inside of the pipe P. The temperature acquisition part 70 then outputs the temperature PVT, which is a result of the measurement, to the controller 150. The controller 150 acquires the temperature PVT from the temperature acquisition part 70.

### (Step S144)

Next, the sensor system 2 corrects the calibration curve based on the measured temperature (a step of correcting the calibration curve based on the measured temperature). Specifically, the controller 150 corrects, using the temperature PVT, the selected calibration curve based on the temperature PVT.

### (Step S150)

The sensor system 2 calculates the gas-liquid ratio from the radio wave strength based on the corrected calibration curve (a step of calculating the gas-liquid ratio from the radio wave strength based on the corrected calibration curve). Specifically, the controller 150 calculates the moisture fraction β from the radio wave strength RP based on the calibration curve corrected in Step S144. The controller 150 then calculates the gas-liquid ratio Raw from the calculated moisture fraction β based on Equation 4.

### <Conclusion>

According to the sensor system of the second embodiment, in a case where the radio wave is transmitted to the inside of the pipe to measure the gas-liquid ratio, the influence of the flow regime can be reduced. Furthermore, according to the sensor system of the second embodiment, the influence of the temperature at the time of measuring the gas-liquid ratio can be reduced.

### Third Embodiment

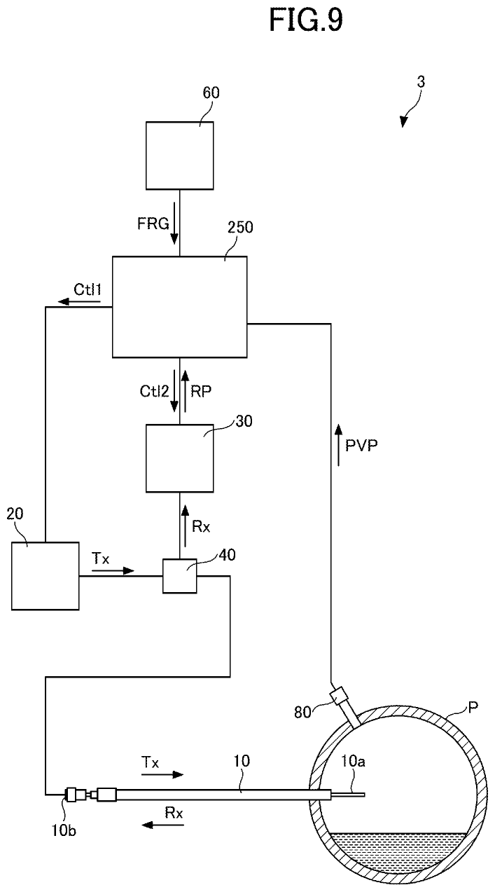

A sensor system according to a third embodiment will be described. The sensor system according to the third embodiment includes a pressure acquisition part instead of the temperature acquisition part of the sensor system according to the second embodiment. The controller of the sensor system according to the third embodiment then calculates the gas-liquid ratio based on the radio wave received by the receiver, the pressure in the inside of the pipe, and the flow regime in the inside of the pipe. FIG. 9 is a diagram for explaining an outline of a configuration of a sensor system 3, which is an example of the sensor system according to the third embodiment.

### <Sensor System 3>

The sensor system 3 includes a pressure acquisition part 80 instead of the temperature acquisition part 70 of the sensor system 2, which is an example of the sensor system according to the second embodiment. The sensor system 3 then includes a controller 250 instead of the controller 150 of the sensor system 2. For the configuration of the sensor system 3 common to the sensor system 1 or the sensor system 2, the description of the sensor system 1 or the sensor system 2 is referred to, and the description thereof will be omitted here.

### [Pressure Acquisition Part 80]

The pressure acquisition part 80 measures pressure in the inside of the pipe P. The pressure acquisition part 80 measures the pressure of the two-phase fluid flowing through the pipe P. The pressure acquisition part 80 transmits the measured pressure PVP to the controller 250.

The pressure acquisition part 80 includes, for example, a pressure gauge. Additionally, the pressure acquisition part 80 may acquire the pressure considered to represent the pressure near the antenna 10 from the outside, for example.

### [Controller 250]

The controller 250 estimates the temperature based on the pressure PVP acquired by the pressure acquisition part 80, in addition to the functions and configuration of the controller 150. The controller 250 then corrects the calibration curve based on the estimated temperature.

The geothermal two-phase flow is basically a two-phase flow in which steam is condensed due to the pressure and temperature. Thus, the geothermal two-phase flow can be considered saturated. In a case where the two-phase fluid is in a saturated state, there is a fixed relationship between the pressure and the temperature of the two-phase fluid. For example, the temperature can be estimated by calculating the saturation temperature from the pressure with practical-use international equations of state IAPWS-IF97 or the like. The calibration curve is corrected in substantially the same manner as the controller 150 of the sensor system 2 based on the temperature estimated from the pressure.

### <Processing in Sensor System 3>

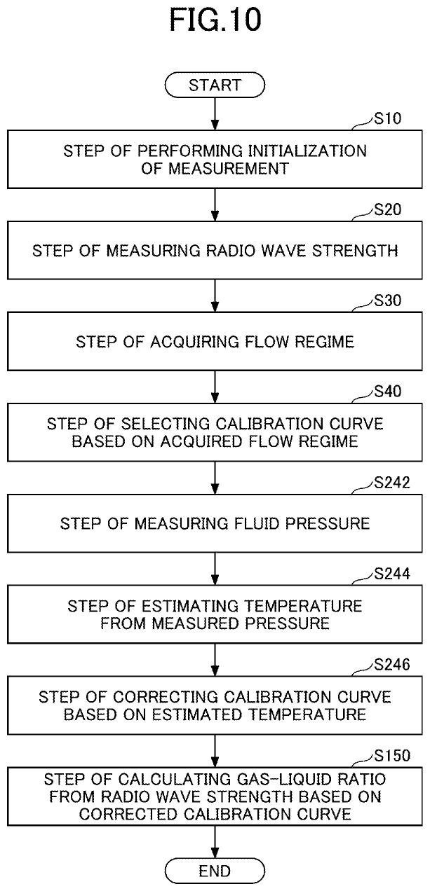

Next, processing in the sensor system 3, which is an example of the sensor system according to the third embodiment, will be described. A method of measuring the gas-liquid ratio according to the third embodiment will be described by describing the processing in the sensor system 3. FIG. 10 is a flowchart for explaining the processing of the sensor system 3, which is an example of the sensor system according to the third embodiment.

Note that, for Step S10, Step S20, Step S30, and Step S40, the processing in the sensor system 1 is referred to, and the description thereof will be omitted here. Furthermore, for Step S150, the processing in the sensor system 2 is referred to, and the description thereof will be omitted here.

### (Step S242)

After Step S40, the sensor system 3 measures a fluid pressure (a step of measuring the fluid pressure). Specifically, the pressure acquisition part 80 measures the pressure in the inside of the pipe P. The pressure acquisition part 80 then outputs the pressure PVP, which is a result of the measurement, to the controller 250. The controller 250 acquires the pressure PVP from the pressure acquisition part 80.

### (Step S244)

Next, the sensor system 3 estimates the temperature from the measured pressure (a step of estimating the temperature from the measured pressure). Specifically, the controller 250 estimates the temperature by calculating the saturation temperature from the pressure with, for example, the practical-use international equations of state IAPWS-IF97 or the like, assuming that the two-phase fluid flowing through the pipe P is in the saturated state.

### (Step S246)

Next, the sensor system 3 corrects the calibration curve based on the estimated temperature (a step of correcting the calibration curve based on the estimated temperature). Specifically, the controller 250 corrects the selected calibration curve by using the temperature PVT estimated in Step S244.

### <Conclusion>

According to the sensor system of the third embodiment, in a case where the radio wave is transmitted to the inside of the pipe to measure the gas-liquid ratio, the influence of the flow regime can be reduced. Furthermore, according to the sensor system of the third embodiment, the influence of the temperature at the time of measuring the gas-liquid ratio can be reduced.

### Fourth Embodiment

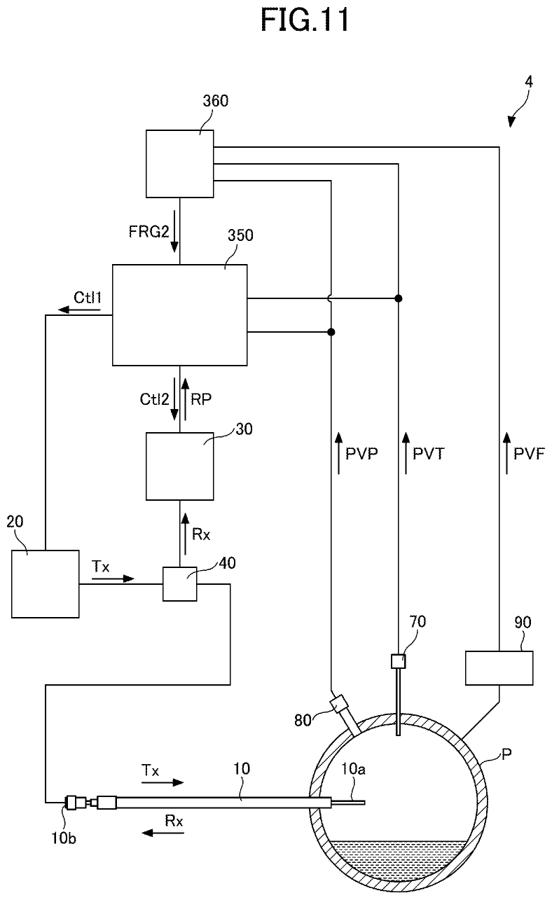

A sensor system according to a fourth embodiment will be described. The sensor system according to the fourth embodiment further includes a temperature acquisition part, a pressure acquisition part, and a flow velocity acquisition part in the sensor system according to the first embodiment. Then, a controller of the sensor system according to the fourth embodiment infers a flow regime based on the temperature, the pressure, and the flow velocity in the inside of the pipe, and calculates the gas-liquid ratio based on the radio wave received by the receiver and the flow regime in the inside of the pipe. FIG. 11 is a diagram for explaining an outline of a configuration of a sensor system 4, which is an example of the sensor system according to the fourth embodiment.

### <Sensor System 4>

The sensor system 4 further includes the temperature acquisition part 70, the pressure acquisition part 80, and a flow velocity acquisition part 90 in the sensor system 1, which is an example of the sensor system according to the first embodiment. The sensor system 4 then includes a flow regime acquisition part 360 instead of the flow regime acquisition part 60 of the sensor system 1. The sensor system 4 further includes a controller 350 instead of the controller 50 of the sensor system 1. Here, for the configuration of the sensor system 4 that is common to any of the sensor system 1, the sensor system 2, or the sensor system 3, the description of any of the sensor system 1, the sensor system 2, or the sensor system 3 is referred to, and the description thereof is omitted here.

### [Flow Velocity Acquisition Part 90]

The flow velocity acquisition part 90 measures a flow velocity of the liquid-phase of the two-phase fluid flowing through the pipe P. The flow velocity acquisition part 90 transmits a flow velocity PVF, which has been measured, to the flow regime acquisition part 360.

The flow velocity acquisition part 90 includes, for example, a velocity meter. Additionally, the flow velocity acquisition part 90 may acquire the flow velocity of the fluid flowing through the pipe from the outside, for example.

### [Flow Regime Acquisition Part 360]

The flow regime acquisition part 360 infers a flow regime based on the temperature PVT acquired by the temperature acquisition part 70, the pressure PVP acquired by the pressure acquisition part 80, and the flow velocity PVF acquired by the flow velocity acquisition part 90. The flow regime acquisition part 360 then outputs a flow regime FRG2, which has been inferred, to the controller 350.

Set air density as ρa (in kilograms per cubic meter), water density as ρw (in kilograms per cubic meter), gas-phase density as ρG (in kilograms per cubic meter), and liquid-phase density as μL (in kilograms per cubic meter). Also, set a viscosity coefficient of water as μw (in pascal seconds), and a viscosity coefficient of a liquid-phase as μL (in pascal seconds). Note that each of the density and the viscosity coefficients is corrected based on the temperature PVT (in ° C.) acquired by the temperature acquisition part 70 and the pressure PVP (in pascals) acquired by the pressure acquisition part 80.

A coefficient λ and a coefficient ψ are calculated by using the density and the viscosity coefficients based on Equation 5 and Equation 6.

$$[ Math 1 ]$$

$$λ = \sqrt{\frac{ρ G}{ρ a} \frac{ρ L}{ρ w}} \qquad Equation 5$$

$$[ Math 2 ]$$

$$ψ = {\frac{ρ w}{ρ L}}^{3} \sqrt{\frac{μ L}{μ w} {( \frac{ρ L}{ρ w} )}^{2}} \qquad Equation 6$$

Ratio of the velocity of the gas-phase to the velocity of the liquid-phase is referred to as a slip ratio SR. The slip ratio SR is obtained from the temperature PVT acquired by the temperature acquisition part 70, the pressure PVP acquired by the pressure acquisition part 80, and the void fraction. The void fraction is calculated with a range of an assumed range. Using the slip ratio SR, a flow velocity VG (in meters per hour) of the gas-phase and a flow velocity VL (in meters per hour) of the liquid-phase are calculated from the flow velocity PVF (in meters per hour) acquired by the flow velocity acquisition part 90.

Set a mass velocity of the gas-phase in the two-phase fluid as G (in kilograms per square meter per hour), and a mass velocity of the liquid-phase in the two-phase fluid as L (in kilograms per square meter per hour). Also, set a total flow path cross-sectional area including the gas-phase and the liquid-phase as S (in square meters), a flow path cross-sectional area of the gas-phase as Sa (in square meters), and a flow path cross-sectional area of the liquid-phase as Sw (in square meters).

VolG (in cubic meters per hour), which is a volume flow rate of the gas-phase, and VolW (in cubic meters per hour), which is a volume flow rate of the liquid-phase, are given by the following equations:

$$VolG = VG \times Sa$$

$$VolW = VL \times Sw$$

MG (in kilograms per hour), which is a mass flow rate of the gas-phase, and ML (in kilograms per hour), which is a mass flow rate of the liquid-phase, can be represented, using the density of the gas-phase as pG and the density of the liquid-phase as ρL, by the following equations:

$$MG = VolG \times ρ G$$

$$ML = VolW \times ρ L$$

The mass velocity G and the mass velocity L are obtained, using the entire flow path cross-sectional area as S, by the following Equation 7 and Equation 8.

$$G = MG \div S \qquad Equation 7$$

$$L = ML \div S \qquad Equation 8$$

The variable P1 (dimensionless) and the variable P2 (in kilograms per square meter per hour) are then calculated by the following Equation 9 and Equation 10.

$$[ Math 3 ]$$

$$P 1 = \frac{L λ ψ}{G} \qquad Equation 9$$

$$[ Math 4 ]$$

$$P 2 = \frac{G}{λ} \qquad Equation 10$$

The flow regime acquisition part 360 determines, in the flow regime map of FIG. 3, positions of the obtained variable P1 and the variable P2. The flow regime acquisition part 360 then obtains the flow regime FRG2 from the positions in the flow regime map of FIG. 3.

Additionally, the flow regime acquisition part 360 may issue a warning that there is a possibility that error becomes large when the determined positions are near the boundary of the flow regime in the flow regime map of FIG. 3.

### [Controller 350]

The controller 350 has the functions and configuration of the controller 50. The controller 350 selects a calibration curve based on the flow regime FRG2 acquired by the flow regime acquisition part 360. Here, although a specific description is omitted, the controller 350 may correct the calibration curve based on the temperature as in the sensor system according to the second embodiment, or may correct the calibration curve based on the pressure as in the sensor system according to the third embodiment.

### <Processing in Sensor System 4>

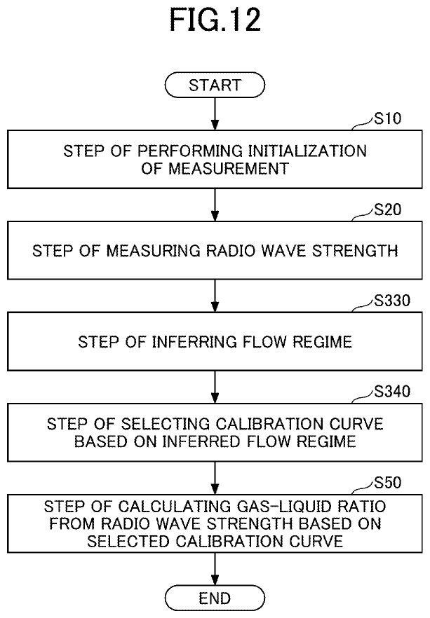

Next, processing in the sensor system 4, which is an example of the sensor system according to the fourth embodiment, will be described. A method of measuring the gas-liquid ratio according to the fourth embodiment will be described by describing the processing in the sensor system 4. FIG. 12 is a flowchart for explaining the processing of the sensor system 4, which is an example of the sensor system according to the fourth embodiment.

Note that, for Step S10, Step S20, and Step S50, the processing in the sensor system 1 is referred to, and the description thereof is omitted here.

### (Step S330)

The sensor system 4 infers a flow regime (a step of inferring the flow regime). Specifically, the flow regime acquisition part 360 infers the flow regime based on the temperature PVT acquired by the temperature acquisition part 70, the pressure PVP acquired by the pressure acquisition part 80, and the flow velocity PVF acquired by the flow velocity acquisition part 90. The flow regime acquisition part 360 then transmits the flow regime FRG2 to the controller 350. The controller 350 receives the flow regime FRG2 from the flow regime acquisition part 360.

### (Step S340)

Next, the sensor system 4 selects a calibration curve based on the inferred flow regime (a step of selecting the calibration curve based on the inferred flow regime). Specifically, the controller 350 selects the calibration curve based on the flow regime FRG2 acquired from the flow regime acquisition part 360.

Note that the sensor system 4 includes the controller 350 and the flow regime acquisition part 360, and the controller 350 may perform the process performed by the flow regime acquisition part 360.

### <Conclusion>

According to the sensor system of the fourth embodiment, in a case where the radio wave is transmitted to the inside of the pipe to measure the gas-liquid ratio, the influence of the flow regime can be reduced. Furthermore, according to the sensor system of the fourth embodiment, even if the flow regime varies, the influence on the estimation of the gas-liquid ratio can be reduced.

The embodiments disclosed herein are to be considered in all respects as illustrative and not restrictive. The above-described embodiments may be omitted, replaced, and modified in various forms without departing from the scope and spirit of the appended claims.

What is claimed is:

1. A sensor system for measuring a gas-liquid ratio of a two-phase fluid flowing through a pipe, the sensor system comprising:
a transmitter configured to transmit a radio wave to an inside of the pipe;
a receiver configured to receive the radio wave from the inside of the pipe; and
a controller configured to calculate the gas-liquid ratio based on a radio wave strength of the radio wave received by the receiver and a flow regime in the inside of the pipe.

2. A sensor system for measuring a gas-liquid ratio of a two-phase fluid flowing through a pipe, the sensor system comprising:
a transmitter configured to transmit a radio wave to an inside of the pipe;
a receiver configured to receive the radio wave from the inside of the pipe;
a temperature acquisition part configured to measure a temperature in the inside of the pipe; and
a controller configured to calculate the gas-liquid ratio based on a radio wave strength of the radio wave received by the receiver, the temperature, and a flow regime in the inside of the pipe.

3. The sensor system according to claim 2, wherein the controller is configured to correct the gas-liquid ratio based on the temperature.

4. A sensor system for measuring a gas-liquid ratio of a two-phase fluid flowing through a pipe, the sensor system comprising:
a transmitter configured to transmit a radio wave to an inside of the pipe;
a receiver configured to receive the radio wave from the inside of the pipe;
a pressure acquisition part configured to measure a pressure in the inside of the pipe; and
a controller configured to calculate the gas-liquid ratio based on a radio wave strength of the radio wave received by the receiver, the pressure, and a flow regime in the inside of the pipe.

5. The sensor system according to claim 4, wherein the controller is configured to correct the gas-liquid ratio based on the pressure.

6. The sensor system according to claim 1, wherein the controller is configured to select, based on the flow regime, a calibration curve to be used from at least two calibration curves for calculating the gas-liquid ratio from the radio wave strength.

7. A sensor system for measuring a gas-liquid ratio of a two-phase fluid flowing through a pipe, the sensor system comprising:
a transmitter configured to transmit a radio wave to an inside of the pipe;
a receiver configured to receive the radio wave from the inside of the pipe;
a temperature acquisition part configured to measure a temperature in the inside of the pipe;
a pressure acquisition part configured to measure a pressure in the inside of the pipe;
a flow velocity acquisition part configured to measure a flow velocity of a liquid-phase flowing through the pipe; and
a controller configured to calculate the gas-liquid ratio based on a radio wave strength of the radio wave received by the receiver, the temperature, the pressure, and the flow velocity.

8. The sensor system according to claim 7, wherein the controller is configured to infer a flow regime in the inside of the pipe based on the temperature, the pressure, and the flow velocity, and calculate the gas-liquid ratio based on the inferred flow regime and the radio wave received by the receiver.

9. The sensor system according to claim 8, wherein the controller is configured to select, based on the flow regime, a calibration curve to be used from at least two calibration curves for calculating the gas-liquid ratio.

10. The sensor system according to claim 7, wherein the controller is configured to correct the gas-liquid ratio based on the temperature or the pressure.

11. A method of measuring a gas-liquid ratio of a two-phase fluid flowing through a pipe, the method comprising transmitting a radio wave to an inside of the pipe and calculating the gas-liquid ratio from a strength of a reflected wave of the radio wave based on a flow regime.

12. A method of measuring a gas-liquid ratio of a two-phase fluid flowing through a pipe, the method comprising transmitting a radio wave to an inside of the pipe and calculating the gas-liquid ratio from a strength of a reflected wave of the radio wave based on a temperature in the inside of the pipe and a flow regime.

13. A method of measuring a gas-liquid ratio of a two-phase fluid flowing through a pipe, the method comprising transmitting a radio wave to an inside of the pipe and calculating the gas-liquid ratio from a strength of a reflected wave of the radio wave based on a pressure in the inside of the pipe and a flow regime.

14. The method of measuring a gas-liquid ratio according to claim 11, the method further comprising inferring the flow regime based on a temperature, a pressure, and a flow velocity of a liquid-phase in the inside of the pipe.
